(19) United States
(12) Patent Application Publication
(10) Pub. No.: US 2018/0215322 A1
(43) Pub. Date: Aug. 2, 2018

(54) ROOFTOP CARGO CARRIER SYSTEM

(71) Applicant: Yakima Products, Inc., Lake Oswego, OR (US)

(72) Inventors: Gian-Marco D'Angelo, Portland, OR (US); Scott A. McFadden, Portland, OR (US); Warren E. Stoneburner, Portland, OR (US)

(73) Assignee: Yakima Products, Inc., Lake Oswego, OR (US)

(21) Appl. No.: 15/884,904

(22) Filed: Jan. 31, 2018

Related U.S. Application Data
(60) Provisional application No. 62/452,924, filed on Jan. 31, 2017.

(51) Int. Cl. B60R 9/045; B60R 9/058

(52) U.S. Cl. CPC B60R 9/045; B60R 9/058

(57) ABSTRACT

A rack for securing cargo on top of a vehicle is disclosed, comprising a front partial frame structure removably coupled to a rear partial frame structure. Each partial frame structure includes a perimetral rail portion with parallel raised side portions, and a transverse crossbar member that is mounted on the raised side portions and generally orthogonal to the raised side portions.

### CROSS-REFERENCES

This application claims the benefit under 35 U.S.C. § 119(e) of the priority of U.S. Provisional Patent Application Ser. No. 62/452,924, filed Jan. 31, 2017, the entirety of which is hereby incorporated by reference for all purposes.

The following related applications and materials are also incorporated by reference, in their entireties, for all purposes: U.S. Pat. No. 9,283,884, and U.S. patent application Ser. Nos. 15/614,515 and 15/614,530.

### INTRODUCTION

Automobile drivers often find that the interior cargo space of their vehicles is insufficient for transporting recreational equipment, building supplies, or other cargo. Solutions to this problem may include use of a roof mounted cargo box or bag. However, a closed cargo carrier is typically limited by specific volumetric dimensions.

Roof mounted cargo boxes or bags may also block and/or preclude simultaneous use of other rooftop racks. To transport longer loads such as lumber, or specialized loads such as bicycles and boats, the whole cargo carrier must be removed and exchanged for a different rack. A more versatile cargo carrier system is desirable, that can accommodate a variety of cargo and allow concurrent use of other roof-mounted carriers.

### SUMMARY

A rack for securing cargo on top of a vehicle is disclosed, including a frame structure with a perimetral rail portion having parallel raised side portions. The frame structure comprises a front partial frame structure removably coupled to a rear partial frame structure. Each partial frame structure may include a perimetral rail portion having parallel raised side portions.

The frame structure may be configured to securely carry a load in transit, and may have a longitudinal member configured to extend perpendicular to a crossbar. The rack may further include a clamp device configured to connect the frame structure to a crossbar on top of a vehicle, and the clamp device may be connected to the longitudinal member. The clamp device may also be adjustable along a length of the longitudinal member.

The rack may include a transverse crossbar member mounted on the raised side portions of the frame structure, and generally orthogonal to the raised side portions. The crossbar member may be adjustably moveable along the side portions, and configured to support cargo securing devices. Each of the partial frame structures may include such a transverse crossbar member.

In some examples, each of the partial frame structures may have a tubular end portion, and the rack may include a coupler configured to securely engage the two tubular end portions without a tool. In some examples, the front partial frame structure may include a tubular structure, and the rack may include a fairing expanse that has a coupler configured to reversibly connect the fairing expanse to the tubular structure manually without a tool.

### BRIEF DESCRIPTION OF THE DRAWINGS

FIG. 1 is a side view of a cargo rack according to aspects of the present disclosure, secured to the rooftop of a vehicle.

FIG. 2 is an isometric view of the cargo rack of FIG. 1, with attached fairing and accessory bars.

FIG. 3 is an isometric view of the rear portion of the frame of the cargo rack of FIG. 2.

FIG. 4 is a side view of the forward and rear portions of the basket of the cargo rack of FIG. 2.

FIG. 5 is a partial exploded view of forward and rear portions of the frame and a clamp rail connector of the cargo rack of FIG. 2.

FIG. 6 is a partial exploded view of forward and rear portions of the frame, an outer frame rail connector, and two upper border rail endcaps of the cargo rack of FIG. 2.

FIG. 7 is an isometric view of an example of an outer frame rail connector.

FIG. 8 is an isometric view of a first side of a crossbar clamp of the cargo rack of FIG. 2, in a clamped and locked position.

FIG. 9 is an isometric view of a second side of the crossbar clamp of FIG. 8, in an unclamped and unlocked position.

FIG. 10 is an isometric view of a bottom side of the crossbar clamp of FIG. 8, clamped to a clamp rail and a floor rail.

FIG. 11 is a cross-sectional view of the crossbar clamp of FIG. 8, along line 11-11.

FIG. 12 is a cross-sectional view of a first end of an accessory bar of the cargo rack of FIG. 2.

FIG. 13 is a partial forward view of the cargo rack of FIG. 2.

FIG. 14 is a partially exploded view of a collar clamp of the cargo rack of FIG. 2.

FIG. 15 is a cross-sectional view of a collar clamp of the cargo rack of FIG. 2, connecting the fairing and the outer frame rail.

FIG. 16 is an oblique isometric view of an illustrative strap-type crossbar clamp according to the present teachings.

FIG. 17 and FIG. 18 are exploded views of the clamp of FIG. 16.

FIG. 19 is an isometric view of an illustrative flexible strap suitable for use in a strap-type crossbar clamp according to the present teachings.

### DETAILED DESCRIPTION

This disclosure provides numerous selected examples of invented devices for transporting cargo on the roof of a vehicle. Many alternatives and modifications which may or may not be expressly mentioned, are enabled, implied, currently possessed, and are supported by the disclosure.

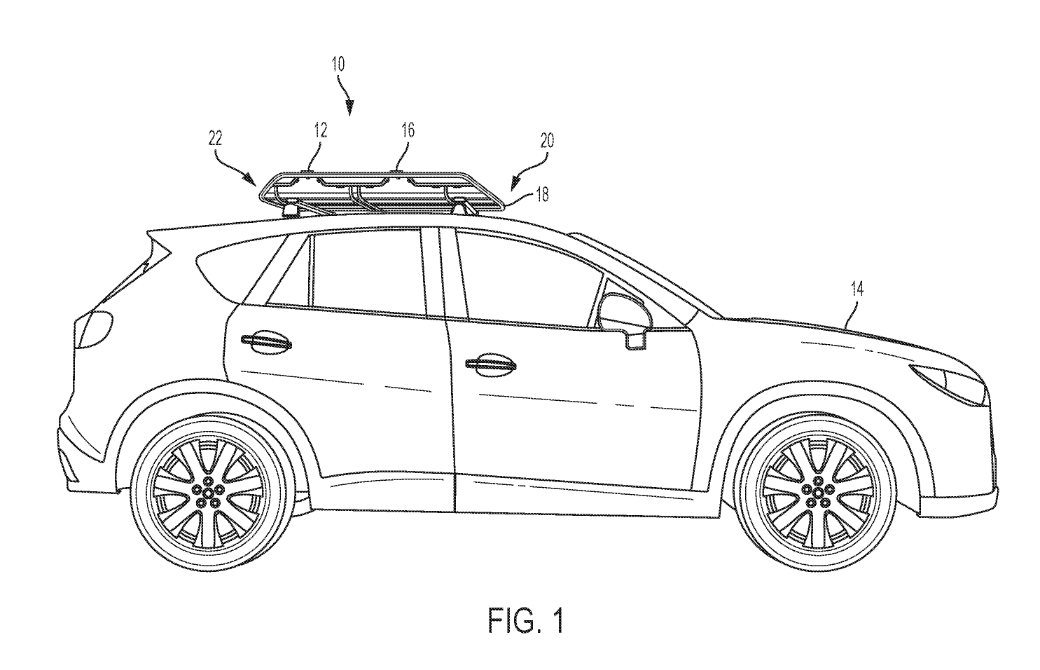

As shown in FIG. 1, a rooftop cargo carrier system 10, as disclosed herein, includes a cargo-carrying basket 12, mountable to crossbars on the rooftop of a vehicle 14 and configured to securely carry a load in transit. The basket includes raised sides 16 at outboard edges relative to the vehicle, which slope down to a basket floor 18 at a forward end 20 and a rear end 22. Raised sides 16 are parallel to one another, and to a direction of travel of vehicle 14.

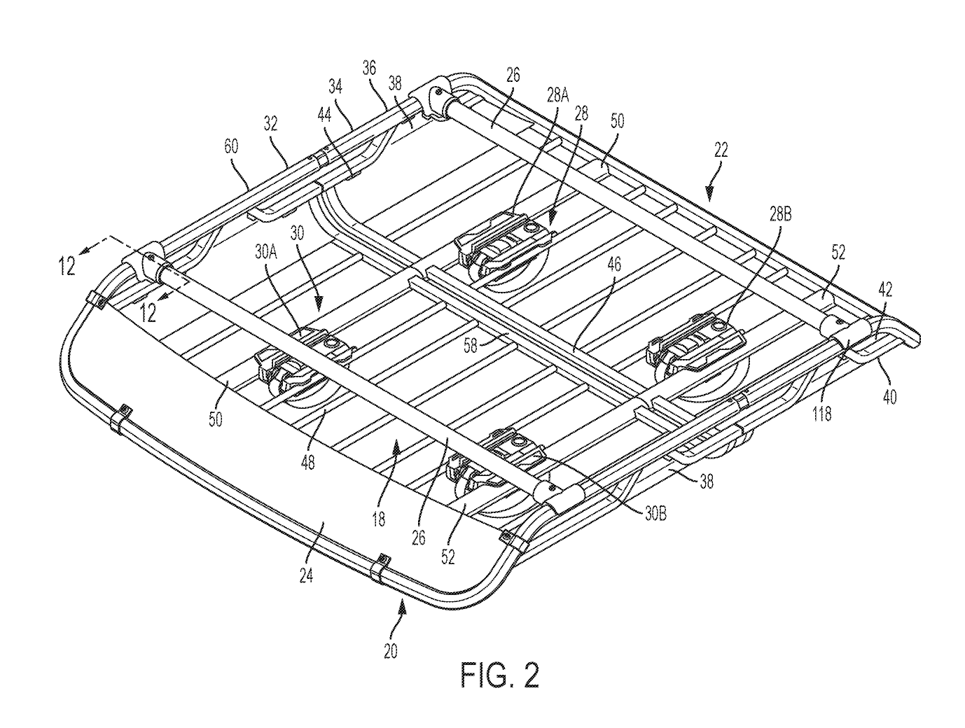

Cargo carrier system 10, which may also be referred to as a cargo rack, is shown in more detail in FIG. 2. The cargo rack includes a removable fairing 24 and a pair of removable accessory bars 26, which are both attachable to basket 12. Fairing 24 is configured for attachment at forward end 20, changing an aerodynamic shape of basket 12. Accessory bars are configured to attach at a plurality of locations along basket 12, each bridging or spanning between raised sides 16 and orthogonal to the raised sides. The transverse accessory bars are also adjustable along the raised sides.

Cargo rack 10 further includes two pairs of crossbar clamps 28 and 30, each configured to mount the basket portion to a vehicle crossbar. Each pair of clamps includes a left clamp and right clamp, which are adjustable along a length of basket 12. The spacing between clamp pairs may be adjusted to correspond to a spacing between vehicle crossbars. In some examples, additional or alternative mounting hardware may be included. For example, removable or integrated T-track connectors may be included in the cargo rack.

Basket 12 of cargo rack 10, may also be described as a frame structure comprising a front partial frame structure, or forward portion 32 and a separate rear partial frame structure, or rear portion 34. Forward portion 32 may be provided in various lengths, and may be interchangeable with other partial frame portions. A user of system 10 may select a forward portion having a length appropriate to their vehicle or to dimensions of intended cargo. In some examples, basket 12 may include extendable or telescoping elements, and/or may include an additional middle section disposed between rear portion 34 and forward portion 32.

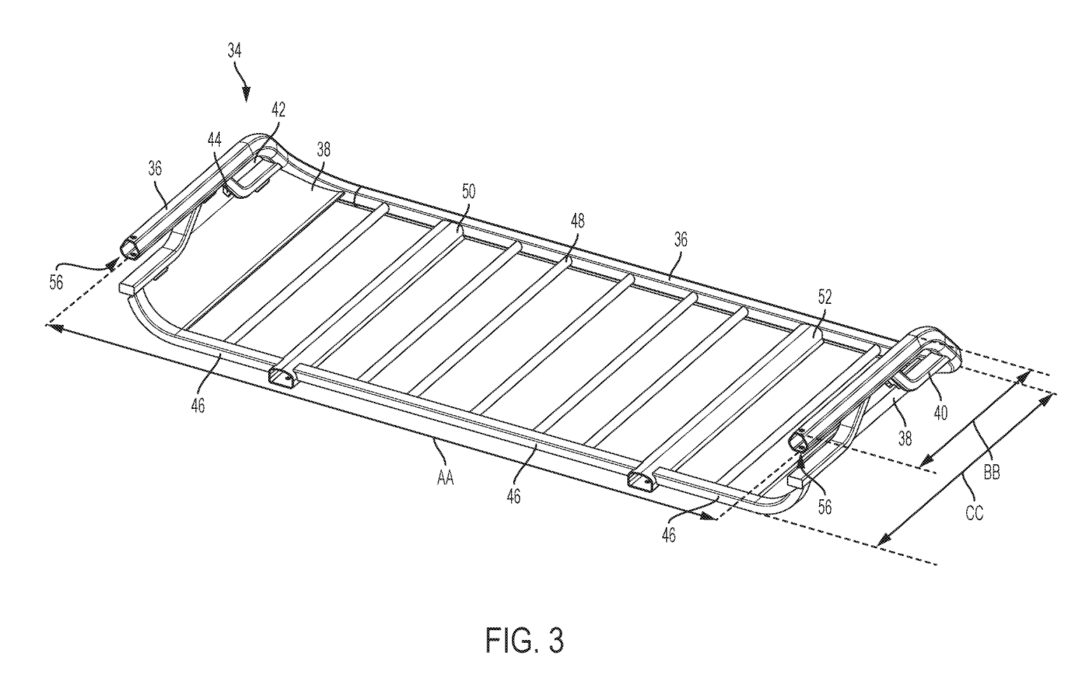

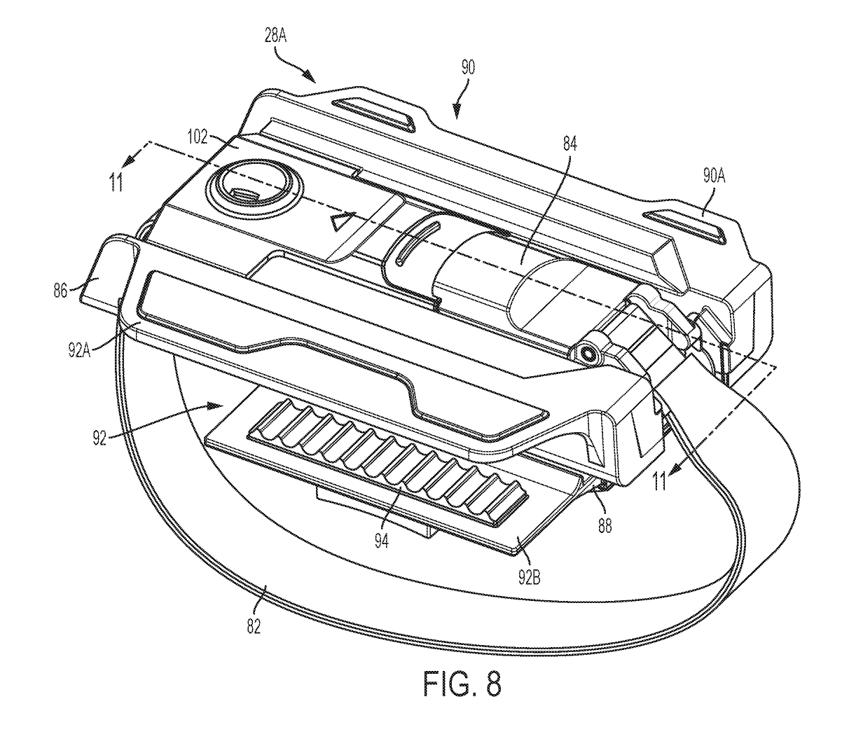

As shown in more detail in FIG. 3, rear portion 34 includes an outer frame rail 36 forming an upper periphery or perimeter for raised sides 16 of basket 12, and sloping downward at rear end 22 to form a rear edge of basket floor 18. Outer frame rail 36 may include any suitable elongate member configured to provide structural support. In the present example, as can be seen more clearly in FIG. 8, outer frame rail 36 is a hollow metal tube having a rounded triangular cross section. Lightweight materials such as extruded aluminum and construction such as hollow tubing may be advantageous for reducing overall weight of cargo rack 10.

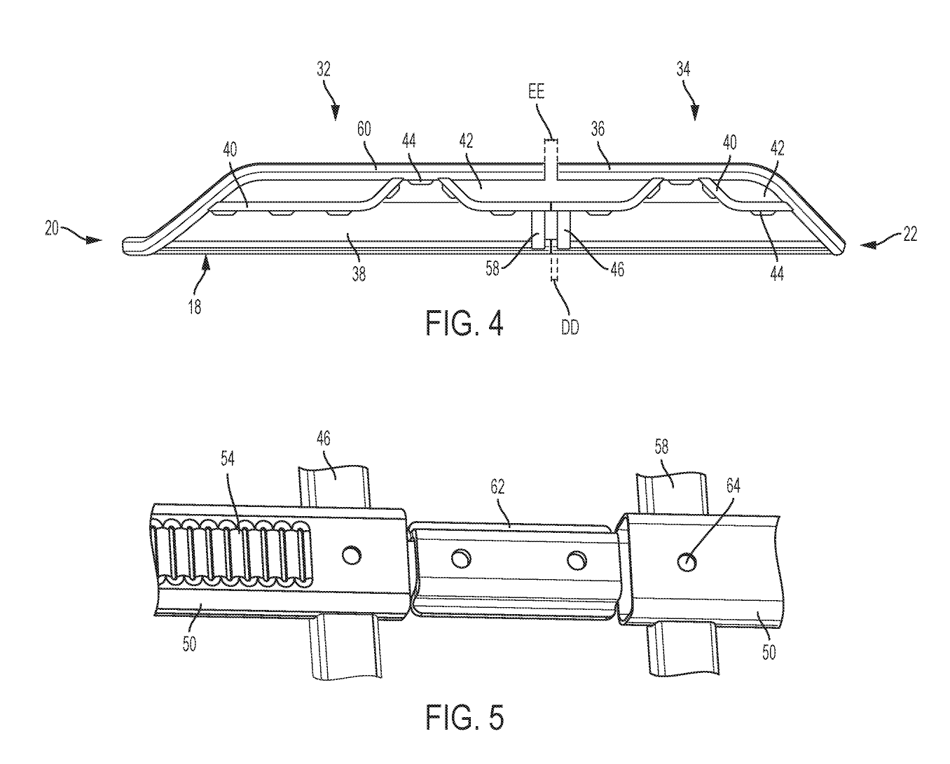

Raised sides 16 of rear portion 34 each include a wall portion 38 with an upper border rail 40. Wall portions 38 are generally solid and curved to conform with the general shape of the basket. The wall portions may include any appropriate material or materials, such as sheet metal, plastic, and/or nylon mesh. Upper border rails 40 are shaped to form gaps 42 between the upper border rail and the outer frame rail. Smaller cutouts 44 are formed in the wall portions proximate the upper border rail, and can be seen more clearly in FIG. 4.

Gaps 42 and cutouts 44 may facilitate the passing therethrough of straps, ropes, and the like, e.g., for tying down cargo in the basket. Any number of gaps and/or cutouts may be included, in any pattern. In some examples, alternative tie-down features may be included additionally or in place of the gaps and cutouts. In some examples, wall portions 38 may extend up to outer frame rail 36, without upper border rails 40.

Referring again to FIG. 3, Basket floor 18 of rear portion 34 comprises the aforementioned outer frame rail 36 at the rear edge, as well as a transverse forward frame member 46, with a plurality of spaced-apart longitudinal members running between the frame rail 36 and forward frame member 46. The longitudinal members are parallel to each other, and when the cargo rack is mounted to a vehicle are also parallel to a direction of travel of the vehicle. The longitudinal members include a plurality of floor rails 48, a left clamp rail 50 and a right clamp rail 52. The clamp rails have generally flattened cross sections and are larger and more substantial as compared with floor rails 48, which are substantially cylindrical.

Spacing between longitudinal members of basket floor 18 may be regular or varied across the width of the basket floor, and may be sufficient to provide an effective support structure while limiting overall weight of the cargo rack. Floor rails 48 may be hollow metal tubing, or may be any appropriate material. In some examples, basket floor 18 may include additional transverse members extending between two or more longitudinal members. In some examples, the basket floor may include additional cargo-securing features such as solid floor panels, or non-slip materials. Additional elements may be spaced from the crossbar clamps, to avoid impeding adjustment of the clamps.

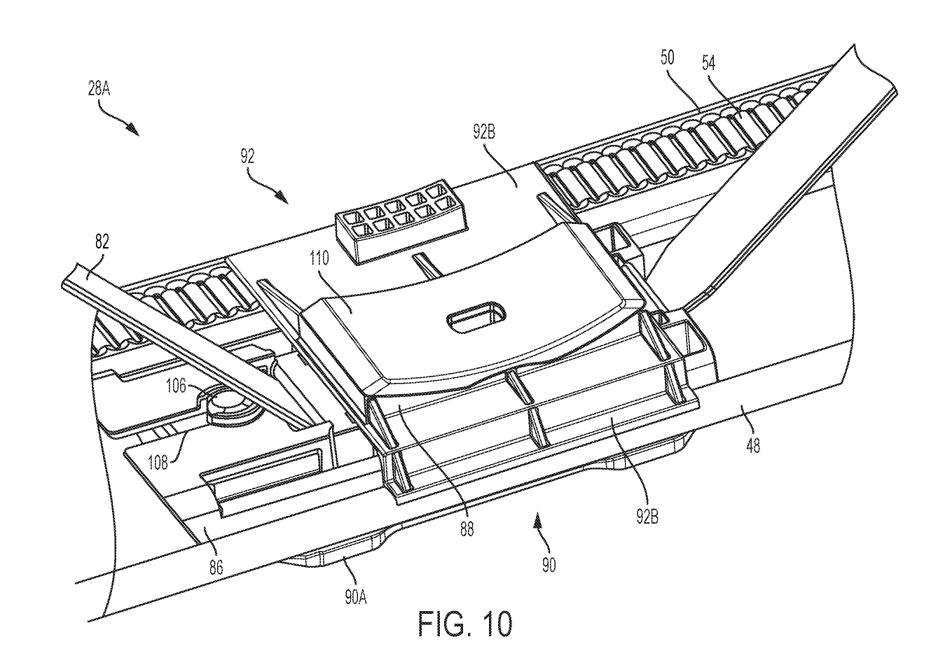

As shown in FIGS. 5 and 10, the flattened cross section of clamp rails 50, 52 facilitates the inclusion of a toothed portion 54 on the underside of each of the clamp rails. Each of the toothed portions is a generally planar length of the clamp rail that has regularly-spaced transverse ribs or teeth. The toothed portions may also be described as ribbed and/or corrugated, or as having an array of transverse grooves. Toothed portions 54 define a range in which the crossbar clamps can be secured, and may therefore be of sufficient length to accommodate most or all expected variation in vehicle crossbar spacing. In some examples, the clamp rails may include other features such as recesses, apertures, and/or tracks configured to engage a clamp.

In the present example, shown in FIG. 3, transverse forward frame member 46 is composed of three elongate members, having rectangular cross sections. A central, linear member extends between left clamp rail 50 and right clamp rail 52. A curved member extends from each clamp rail to the respective upper border rail 40. Any structurally sound combination of members may form transverse forward frame member 46, and may extend between upper border rails 40 and/or terminal ends of outer frame rail 36.

Rear portion 34 of basket 12 may be described as having three primary dimensions, a width AA, an upper length BB, and a floor length CC. Floor length CC, which is defined between the rear edge of outer frame rail 36 and transverse forward frame rail 46, is greater upper length BB, which is defined as length of a linear section of outer frame rail 36 proximate a terminal end 56.

Referring again to FIG. 2, forward portion 32 is substantially similar to rear portion 34. Forward portion 32 also includes outer wall portions 38 and upper border rails 40, forming gaps 42, and cutouts 44, all substantially as described above with respect to corresponding components. A transverse rear frame member 58 forms a rear connection point for each of a plurality of longitudinal members that comprise the floor of the forward portion, including floor rails 48. As with the rear portion, basket floor 18 also includes a left clamp rail 50 and a right clamp rail 52, each including a respective toothed portion on their undersides.

An outer frame rail 60 of forward portion 32 is configured to mate with outer frame rail 36 of rear portion 34. Outer frame rail 60 has terminal ends 56 that match with corresponding terminal ends 56 of outer frame rail 36, such that they form a generally continuous outer frame rail for the entire basket. In other words, basket 12 has a perimetral rail portion with raised parallel sides that includes outer frame rails 36 and 60.

Outer frame rail 60 of the forward portion has a curvature proximate front edge 20 of basket 12 that is configured for connection of a fairing. The curvature of outer frame rail 60 accordingly differs from outer frame rail 36 of rear portion 34. In some examples, outer frame rails 36 and 60 may have a matching shape, or may differ in shape at other sections.

As shown in FIG. 4, upper length BB and floor length CC of forward portion 32 are each greater than corresponding lengths of rear portion 32. Width AA, shown in FIG. 3, is equal between portions. Right clamp rails 52 of forward portion 32 and rear portion 34 of meet end-to-end, as shown. Similarly, left clamp rails 50 meet end-to end. Clamp rails 50, 52 and upper border rails 40 of each basket portion extend a distance DD beyond terminal end 56 of the outer frame rail. A gap EE is thereby formed between the two outer frame rails when corresponding clamp rails and upper border rails are in contact, to facilitate coupling of the outer frame rails.

Distance DD, gap EE, and spacing between any corresponding members may be selected to facilitate a connection type. In some examples, terminal ends 56 of outer frame rails 36, 60 may meet and the left and right clamp rails may each form a gap. Any effective spacing or connection may be used between forward portion 32 and rear portion 34.

FIG. 5 shows a clamp rail connector 62 used in the present example, which is bolted to corresponding holes 64 on the undersides of the clamp rails to connect or couple the two basket portions. Clamp rail connector 62 is a metal plate with curved edges that is configured to be entirely received inside the clamp rails.

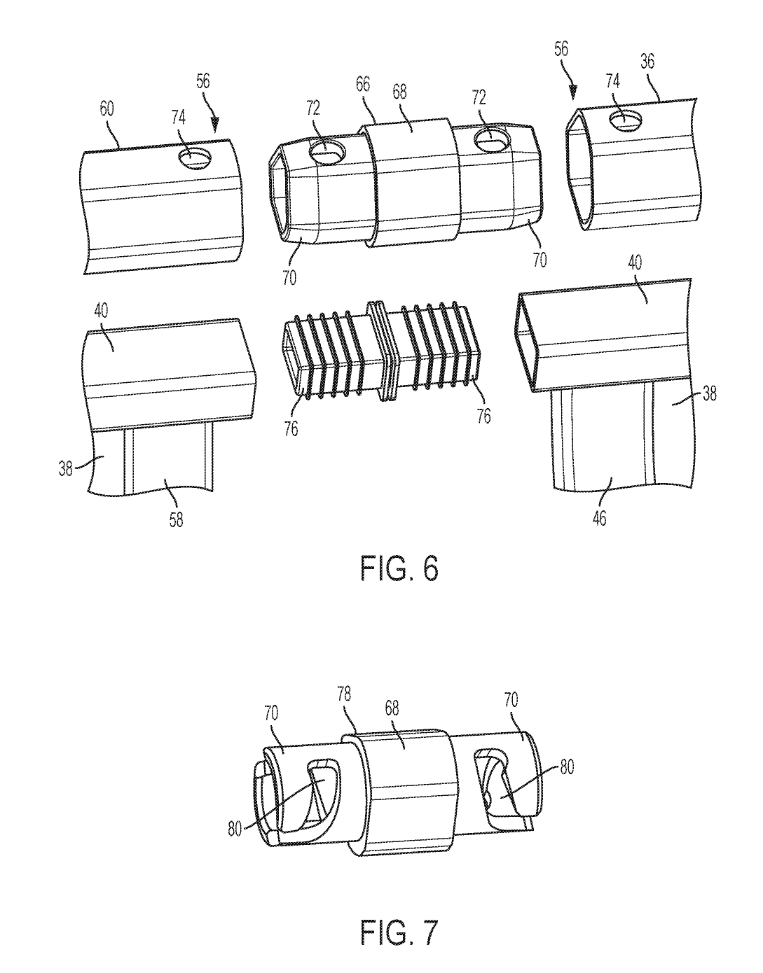

FIG. 6 shows a connector piece 66 configured to connect corresponding terminal ends 56 of outer frame rail 36 and outer frame rail 60, thereby also coupling the two basket portions. A matching connector piece connects corresponding terminal ends of outer frame rails 36, 60 on the opposite side of the basket. Each of the connector pieces includes a central portion 68 sized and shaped substantially the same as the frame rails, and two smaller end portions 70 configured to mate with a friction fit inside the hollow tubular end portions of the outer frame rails.

Central portion 68 has a length matching gap EE between frame rail ends, shown in FIG. 4. Each end portion 70 includes upper and lower apertures 72 corresponding to upper and lower apertures 74 in terminal ends 56 of the outer frame rails. A pair of fasteners such as bolts or screws can be inserted through aligned apertures 72 and 74 to secure the connector piece in place, and thereby secure the forward and rear portions of the basket together. In the present example, sleeve bolts are used for smooth and easy fastening.

Also shown in FIG. 6 is a pair of endcaps 76. The endcaps are configured to mate with a friction fit inside upper border rails 40. Raised ridges on the body of the endcap may provide a tight fit, and help to retain the endcaps in the upper border rails. Each endcap also has a flat end, such that two endcaps contact squarely when two upper border rails are brought together. In some examples, endcaps 76 may be replaced by a connector, which may be similar to clamp rail connector 62 or connector piece 66, or may be of any effective design.

FIG. 7 shows an alternative example of a connector piece 78, also configured to connect corresponding terminal ends of outer frame rail 36 and outer frame rail 60. Similarly, the connector piece includes a central portion 68 sized and shaped substantially the same as the frame rails, and two smaller end portions 70. Each smaller end portion 70 is generally cylindrical and includes a pair of curved channels 80. Each channel extends from an outer edge of the end portion 70, circumferentially around the end portion and toward central portion 68. All four curved channels may be matching, but mirrored with respect to one another.

For connection with connector piece 78, terminal ends 56 may each include a vertical member such as a bolt or bar extending through the hollow interior of the outer frame rails. Connector piece 78 may be inserted into terminal ends 56 such that curved channels 80 on each end portion 70 are aligned with the corresponding vertical member. Central portion 68 may be rotated about an elongate axis of connector piece 78, such that the vertical members are urged, by engagement with curved channels 80, along the channels and therefore toward central portion 68. Connector piece 78 may therefore be described as pulling terminal ends 56 toward one another as the connector piece is twisted. In some examples, channels 80 may have alternative shapes such as angled slots or any shape configured to urge the vertical members toward central portion 68.

Curved channels 80 and the vertical members may be dimensioned and/or disposed such that when the vertical members reach an interior end of the channels, central portion 68 is snug against terminal ends 56. In such a configuration, connector piece 78 may resist motion of outer frame rails 36, 60 along the elongate axis of the connector piece relative to one another.

Referring again to FIG. 2, a pair of crossbar clamps is removably attached to basket floor 18 of each portion of basket 12. That is, pair of crossbar clamps 30 is attached to the floor of forward portion 32 and pair of crossbar clamps 28 is attached to the floor of rear portion 34. Each clamp is moveably coupled to a clamp rail 50 or 52 on one side and a floor rail 48 on the other. Each clamp is mounted to a different longitudinal member or members of the basket floor. As shown, crossbar clamp pairs 28 and 30 are substantially identical, each left clamp 28A, 30A is a mirror image of the corresponding right clamp 28B, 30B. Accordingly, only left clamp 28A and clamp rail 50 will be described, with right clamp 28B mentioned as needed.

FIG. 8 shows clamp 28A, which is a strap-type clamp, similar to the clamps described in the documents listed in the Cross Reference section above, and to another embodiment of a crossbar clamp 200 described below. Clamp 28A is configured to secure the cargo rack to a crossbar of a vehicle. Because such crossbars are not uniformly sized, shaped, or spaced on all vehicles, the crossbar clamp is adjustable, both in terms of longitudinal placement on the basket and in terms of the clamping mechanism used to mount onto the crossbar.

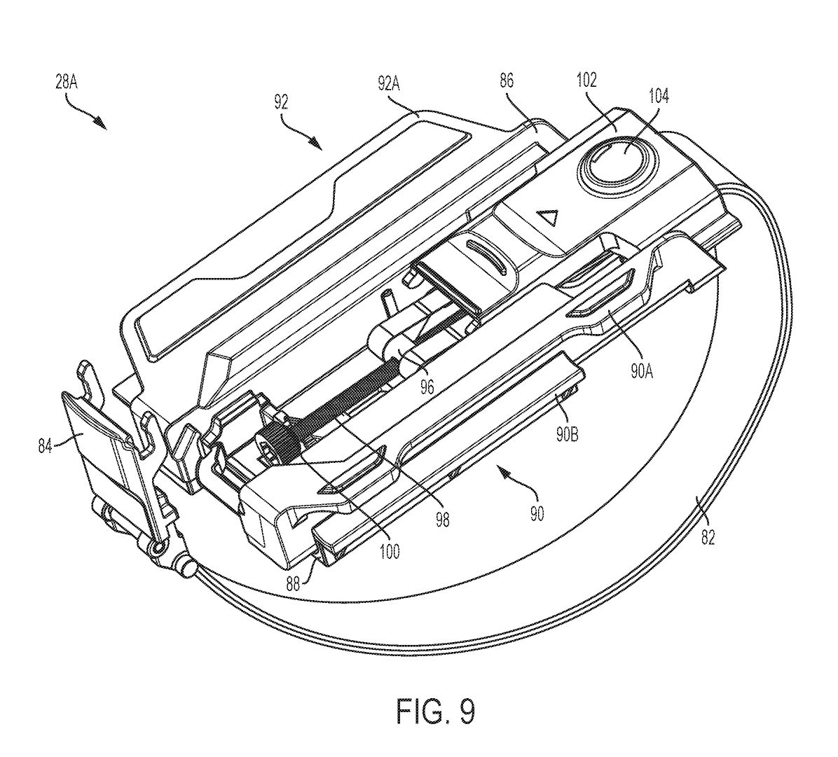

Clamp 28A includes a flexible strap 82, connected to a cam lever 84. To facilitate longitudinal adjustability, clamp 28 includes an upper body portion 86 and a lower body portion 88, which are vertically movable relative to each other. Along a first lateral side of clamp 28A, upper body portion 86 extends out to form an upper jaw 90A and on a second side lateral side the upper body portion extends out to form an upper jaw 92A. Similarly, lower body portion 88 extends out along each lateral side to form lower jaws 90B and 92B, where lower jaw 90B is depicted in FIG. 9. Upper jaw 90A of upper body portion 86 and lower jaw 90B of lower body portion 88 form a set of floor rail-engaging jaws 90 on one lateral side of clamp 28A. On the opposing lateral side, upper jaw 92A of upper body portion 86 and lower jaw 92B of lower body portion 88 form set of clamp rail-engaging jaws 92.

Upper jaw 90A and lower jaw 90B of floor-rail engaging jaws 90 have concave inner surfaces, shaped to conform to a floor rail 48, as shown in FIG. 10. By contrast, upper jaw 92A and lower jaw 92B are deeper, and have generally planar inner surfaces, to conform to the larger, flattened shape of left clamp rail 50. When closed, the jaws fix the clamp at a desired longitudinal location along the clamp rail and floor rail. Right clamp 28B, has jaws 90 and 92 on mirrored lateral sides, and attaches to right clamp rail 52. Secure clamping to clamp rail 50 is further enhanced by a set of teeth 94, shown in FIG. 8 on an upper surface of lower jaw 92A of clamp rail-engaging jaws 92. The teeth are configured to interface with toothed portion 54 of the corresponding clamp rail, shown in FIG. 10. Teeth 94, which may also be described as an array of transverse ridges or regularly spaced protrusions may be shaped to correspond to toothed portion 54. Loosening the crossbar clamp, by opening cam lever 84, loosens the side jaws and disengages the teeth, thereby permitting a longitudinal repositioning of the clamps with respect to the basket.

To clamp to a crossbar, a user may release cam lever 84 from the clamp and slide the clamp along the clamp rail to a position above the crossbar, and rest the underside of the clamp on the crossbar. Then, the user may thread the cam lever and strap 82 under the crossbar before mating the cam lever with a recess on the body of the clamp. Rotating the cam lever may tighten strap 82 against the crossbar, securing the clamp to the crossbar. The cam action of lever 84 may also bring upper body portion 86 and lower body portion 88 closer together, securing the clamp to the adjacent clamp rail and floor rail.

As shown in FIG. 9, strap 82 extends from a barrel nut 96 at one end, to cam lever 84 at the other end. The effective length of the strap may be adjusted using an adjustment screw 98, on which the barrel nut rides. Adjustment screw 98 has an adjustment knob 100 at one end for this purpose.

Clamp 28A is lockable, using a sliding lock cover 102, which travels longitudinally to trap or release the cam lever. The lock cover includes a lock core 104 with an asymmetrical flange 106 at a distal end that interfaces with a corresponding slot 108 in the base of the clamp, as shown in FIG. 10. In FIG. 10, lock cover 102 is in a closed position, but lock core 104 is in an unlocked position. The lock core may be turned to a locked position using a key, approximately 90 degrees from the unlocked position. FIG. 8 also shows the lock cover in a closed position, while FIG. 9 shows the lock cover in an open position.

Also shown in FIG. 10 is a pad 110 mounted on an underside of clamp 28A. The pad is configured to engage the crossbar, securely seating the clamp on the crossbar and preventing damage by the clamp. Pad 110 may include a compressible material, and/or a material of high frictional coefficient appropriate to grip the crossbar and resist shear forces between the clamp and crossbar. The pad may reduce scratching or scoring of the crossbar, and facilitate clamping on a range of crossbar shapes.

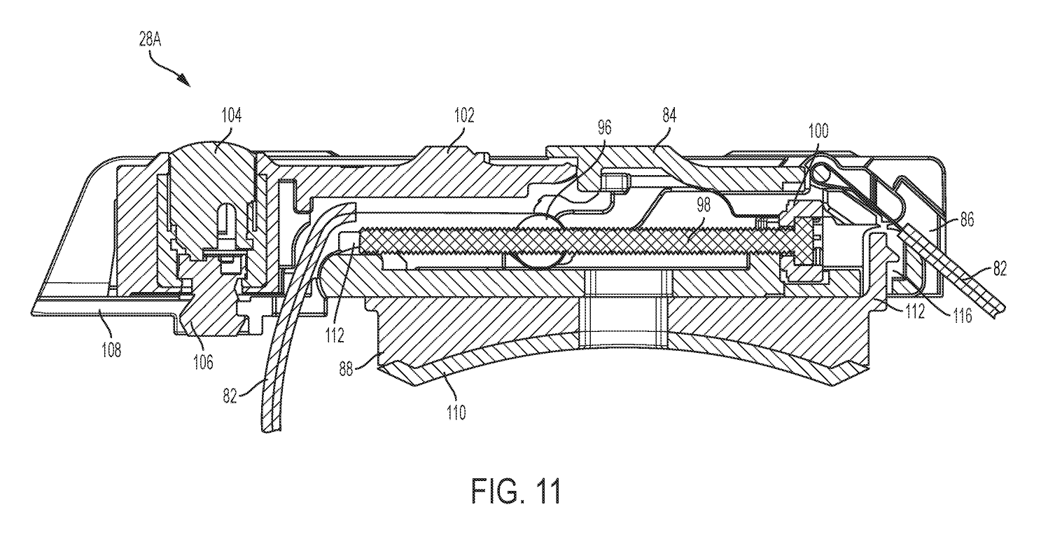

FIG. 11 is a cross-section of clamp 28A, taken along line 11-11 in FIG. 8. Lower body portion 88 includes interlocking fingers 112 at forward and rear ends of the body portion respectively. Each finger is received in a recess 116 of upper body portion 86. Recesses 116 provide more space than is required to accommodate fingers 112, allowing the fingers to freely move vertically within the recesses. Forward interlocking finger 112 includes a protruding tab to engage a shoulder in the corresponding recess 116. This engagement prevents finger 112 from withdrawing from recess 116, and limits the range of motion of lower body portion 88 relative to upper body portion 86. Rear interlocking fingers 112 have a curved shape that matches a curve, not shown, in corresponding recess 116, which similarly limits the range of motion of lower body portion 88. This limited range may prevent upper and lower body portions from being separated at any time, or clamp 28A being removed from the adjacent floor rail 48 and clamp rail 50.

Strap 82 is anchored at both ends to upper body portion 86. When cam lever 84 and the strap are threaded around a crossbar and cam lever is 224 is used to tighten the strap around the crossbar, lower body portion 88 is sandwiched between the crossbar and the upper body portion. Lower body portion 88 is accordingly pushed up relative to upper body portion 86. Accordingly, the floor rail-engaging jaws and clamp rail-engaging jaws will clamp onto the adjacent floor rail 48 and clamp rail 50, respectively.

As shown in FIG. 2, accessory bars 26 are removably attachable to basket 12. The bars are depicted as hollow metal cylindrical tubes, but may also be shaped similarly to aerodynamic vehicle crossbars, or may be any sufficiently strong and lightweight elongate member. Any effective mounting mechanism may be included on the basket and/or the accessory bars. The bars may be configured to act as crossbars, for example to support cargo securing devices and/or recreational equipment racks like bicycle or boat racks. One or both of the bars may also be attached to basket 12 such that the bar or bars act as a cargo stop, limiting motion of cargo transported in cargo rack 10. The bars may be removed and attached as needed during use of the cargo rack.

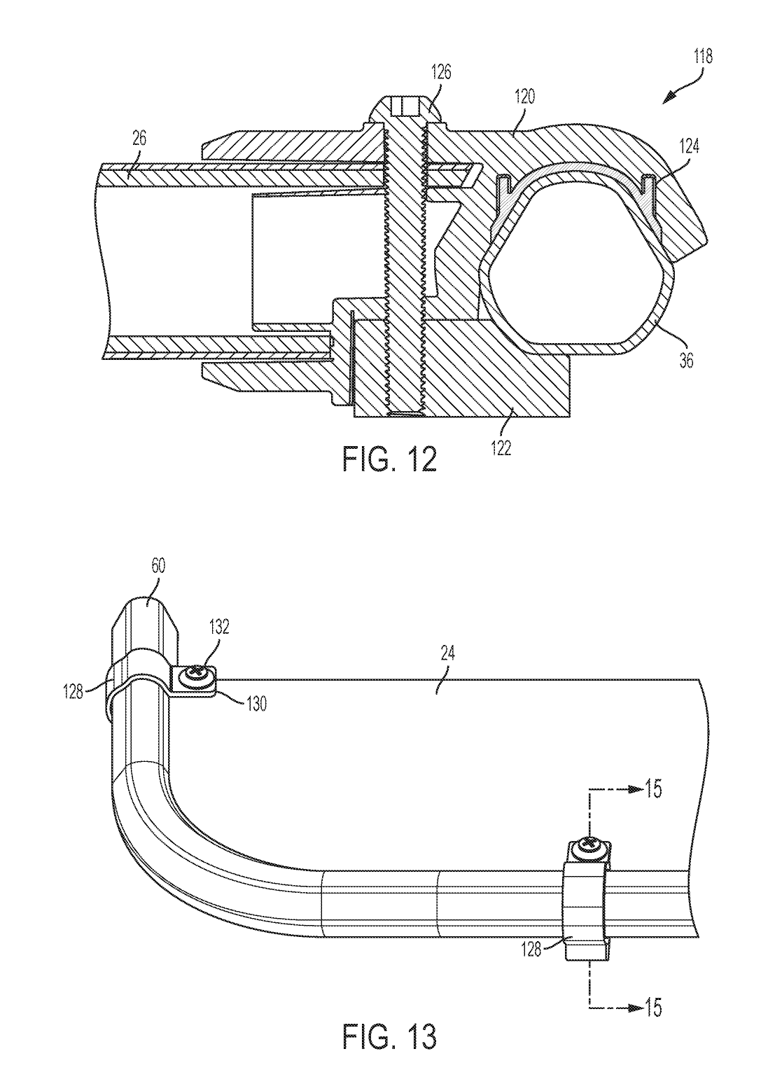

Each bar in the present example includes a substantially identical end clamp 118 at first and second ends of the bar. A cross-section of one end clamp, along line 12-12 in FIG. 2 is shown in FIG. 12. The end clamp includes a fixed upper jaw 120 and a movable lower jaw 122. Each jaw is shaped to conform to outer frame rails 36 and 60, though rail 36 is depicted in FIG. 12. Upper jaw 120 includes a pad 124 on a contact side. Pad 124 may include a high grip or anti-slip material such as rubber or silicone. The pad may reduce lateral motion of the accessory bar due to shear forces between the bars and outer frame rail.

An actuator screw 126 passes vertically through the clamp, through an unthreaded aperture in upper jaw 120 and into a threaded aperture in lower jaw 122. Turning the screw may therefore cause the lower jaw to move up and down. To attach an end of accessory bar 26 to outer frame rail 36, a user may turn actuator screw 126 to move lower jaw 122 to admit the outer frame rail between upper jaw 120 and lower jaw 122. With upper jaw 120 seated on top of the outer frame rail, the user may turn actuator screw 126 in the opposite direction to tighten lower jaw 122 against a lower surface of the outer frame rail.

Returning to FIG. 2, cargo rack 10 also includes removable fairing 24. In some examples, fairing 24 may include any suitable structure or expanse configured to function as a wind screen and to be attachable to a front portion of basket 12. In the example depicted in the drawings, fairing 24 is a generally planar, elongate piece of plastic (e.g., ABS plastic) shaped to fit into a front contour of basket 12.

As FIG. 13 shows in more detail, a plurality of collar clamps 128 attach fairing 24 to outer frame rail 60 of forward portion 32. A connector tab 130 of each collar clamp 128 overlaps fairing 24, and a plastic plug connector 132 extends through aligned apertures in the connector tab and fairing to secure the collar clamp to the fairing. In the present example, a plastic plug connector is used, but any effective fastener may be used. The collar is coupled to the frame rail by wrapping the collar around the rail and engaging a ratcheting mechanism.

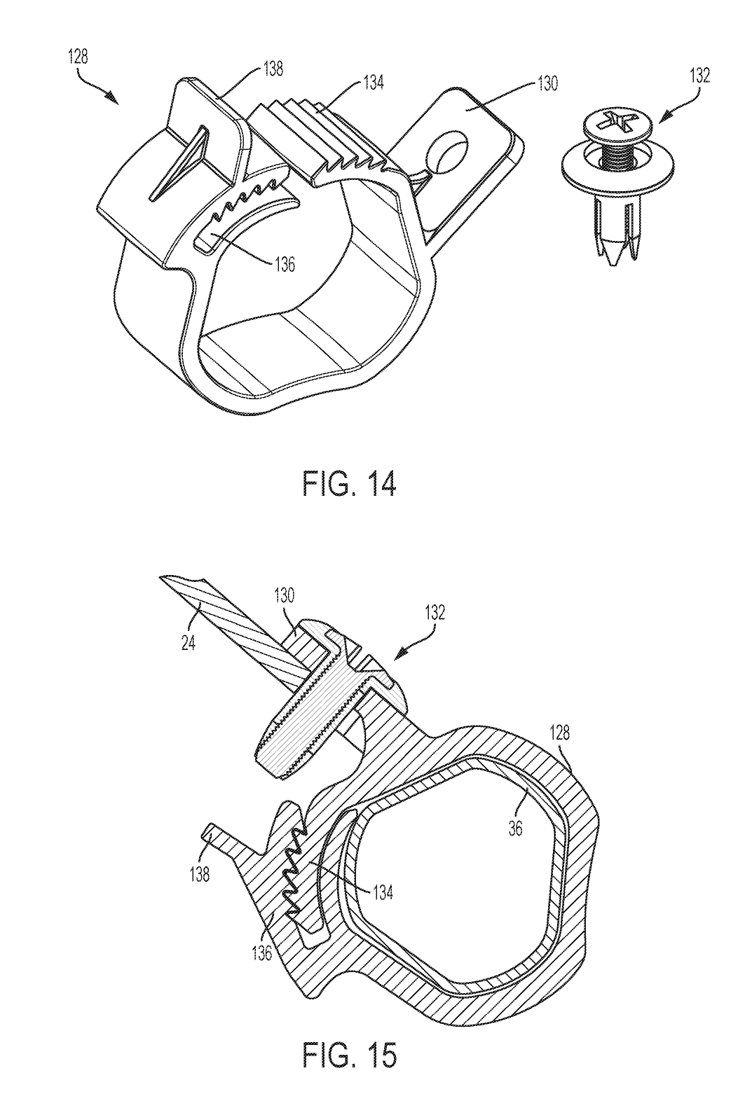

FIG. 14 shows a collar clamp 128 and a plastic plug connector 132. The clamp includes a toothed member 134 and a toothed receptacle 136 on first and second end portions. These end portions are configured as a ratcheting mechanism, each having teeth inclined at a matching angle to facilitate a ratcheting action when the toothed member is inserted into the toothed receptacle. The collar is tightenable, but is prevented from loosening by the meshed teeth.

FIG. 15 shows a cross section of collar clamp 128 in a fully tightened position, clamped around outer rail 60 and connected to fairing 24. The collar clamp has a rounded triangular cross-sectional shape, conforming to the outer frame rail. The non-circular shape may help prevent unwanted rotation of collar clamp 128 relative to the outer frame rail. Collar clamp 128 may also have any shape that effectively clamps the outer frame rail.

To remove the clamp, force may be applied to a finger tab 138 extending from an outer side of toothed receptacle 136, prying apart the opening of the receptacle and releasing toothed member 134. Collar clamp 128 is sufficiently flexible that toothed receptacle 136 and toothed member 134 may be urged apart to allow outer rail 60 to pass between, removing the clamp entirely from the rail. Collar clamp 128 may therefore manually be reversibly connected to the outer frame rail without using any tools.

With all collar clamps disengaged from outer rail 60, fairing 24 and the attached collar clamps may be removed from the cargo rack and temporarily stored. Without fairing 24 removed, the cargo rack may be configured for transportation of oversize cargo. Fairing 24 may be reattached to reduce wind noise and drag generated by the cargo rack. Because collar clamps 128 do not require use of tools for installation or removal, the user may quickly and easily reconfigure the cargo rack as needed.

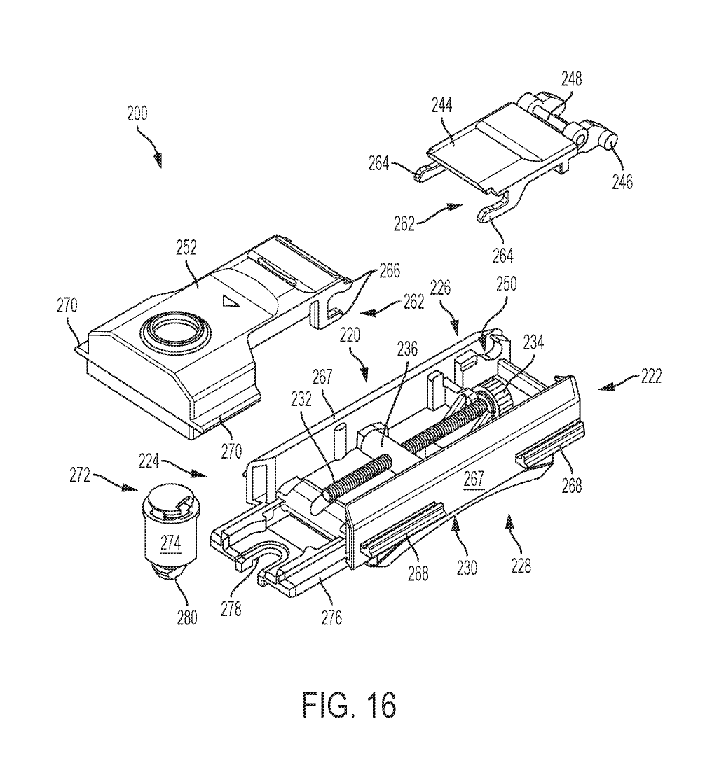

FIGS. 16-19 depict various aspects of rear crossbar clamp 200, which comprises a positionable, adjustable, and lockable strap clamp. Crossbar clamp 200 includes a body 220 with a first end portion 222, a second end portion 224, an upper portion 226, and a lower portion 228 having a cushioned concave surface 230 configured to contact a top side of the crossbar. A threaded rod 232 is rotatably coupled to upper portion 226 of body 220. Threaded rod 232 has a dial 234 that is manipulable to rotate the rod. A traveling member 236 (e.g., a barrel nut) is in threaded engagement with rod 232 and travels along the rod in response to rotation thereof.

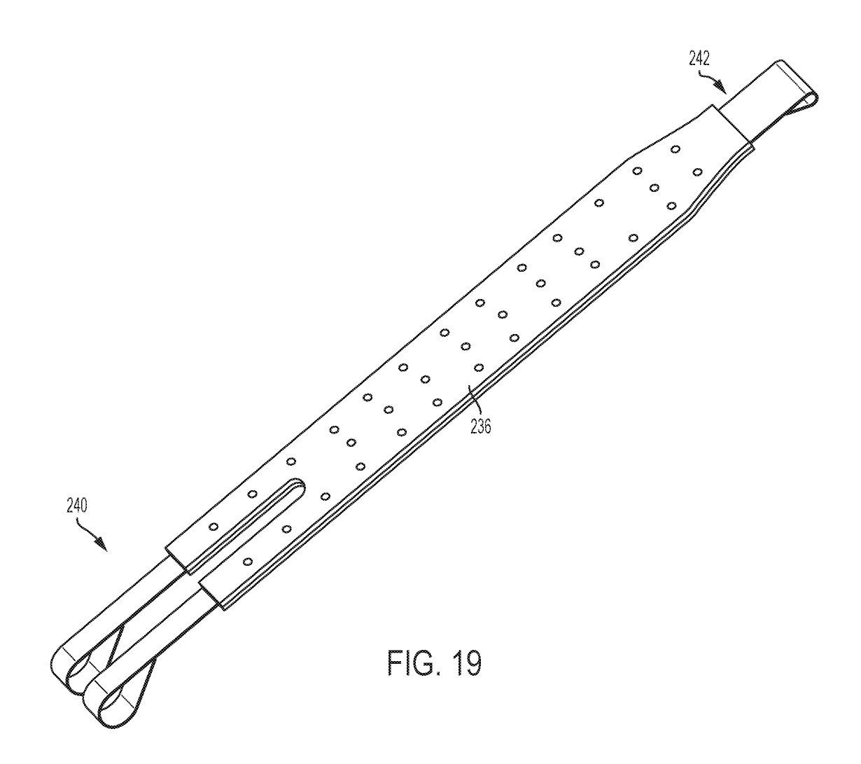

A flexible strap 238 (see especially FIG. 19) has a proximal end 240 coupled to traveling member 236 such that the flexible strap is coupled to the first end portion of the body. Strap 238 has an effective length that can be lengthened or shortened, as described below, to fit the crossbar. A distal end 242 of strap 238 is coupled to a lever plate 244 (also referred to as an over-center plate). Lever plate 244 has a transverse shaft portion 246, which may comprise two lateral extensions. Distal end 242 of strap 238 is pivotably attached to lever plate 244 by a mounting pin 248 disposed adjacent shaft portion 246.

Mounting pin 248 is spaced from the shaft portion along a length of the lever plate, facilitating an over-center mechanism when securing the lever plate to body 220. Second end portion 224 of the body includes a slot 250 configured to receive shaft portion 246 of the lever plate for this purpose, such that the lever plate is releasably engageable with the second end portion.

Rotation of dial 234 causes the traveling member to move along rod 232, causing more or less of strap 238 to be housed within body 220, thereby altering the effective length of the strap. This may be done, for example, to adapt strap 238 to differently-sized crossbars. Lever plate 244 is also pivotably transitionable, when shaft portion 246 is seated in slot 250, between an open position 258 and a closed position 260, such that transitioning from the open position to the closed position causes an over-center action and a decrease in the effective length of the flexible strap. This facilitates tightening of the strap around the crossbar.

A cover plate 252 is coupled to first end portion 222 of the body. Cover plate 252 is slidable along the body between a first position 254 and a second position 256. Cover plate 252 blocks lever plate 244 from opening when the lever plate is in closed position 260 and the cover plate is in first position 254. Accordingly, the lever plate is prevented by the cover plate from transitioning to the open position until the cover plate is slid into second position 256. In some examples, respective opposing ends of cover plate 252 and lever plate 244 include finger portions 262 configured to interdigitate when the lever plate is in the closed position and the cover plate is in the first position, such that the cover plate and the lever plate are interlockable. For example, lever plate 244 includes finger portions 264 configured to interlock with finger portions 266 on cover plate 252.

Body 220 includes a pair of side walls 267 extending from the first end portion to the second end portion, the pair of side walls configured to prevent access to threaded rod 232. (Lever plate 244 is also configured to prevent access to the dial and threaded rod). Body 220 may include side tabs 268, e.g., on walls 267. Side tabs 268 may include any suitable protrusions or other structures configured to interface with lower slots 202 on proximate longitudinal members or basket ribs, forming a prismatic or sliding joint. In some examples, side tabs may be reverse-tapered or shaped to facilitate retention of the tabs within the slots. Cover plate 252 may include its own side tabs 270, to retain the cover plate in the slots and to facilitate sliding of the cover plate between first and second positions. This arrangement facilitates adjustability of the position of the clamp device relative to the carrier (or other rack accessory) along a length of the slots. In some examples, only one slot is used. In some examples, only one tab 268 is present.

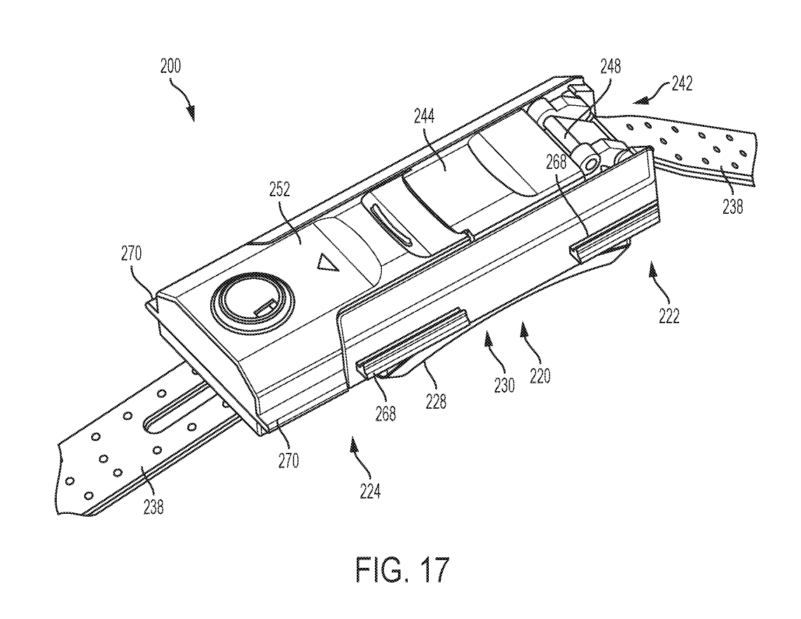

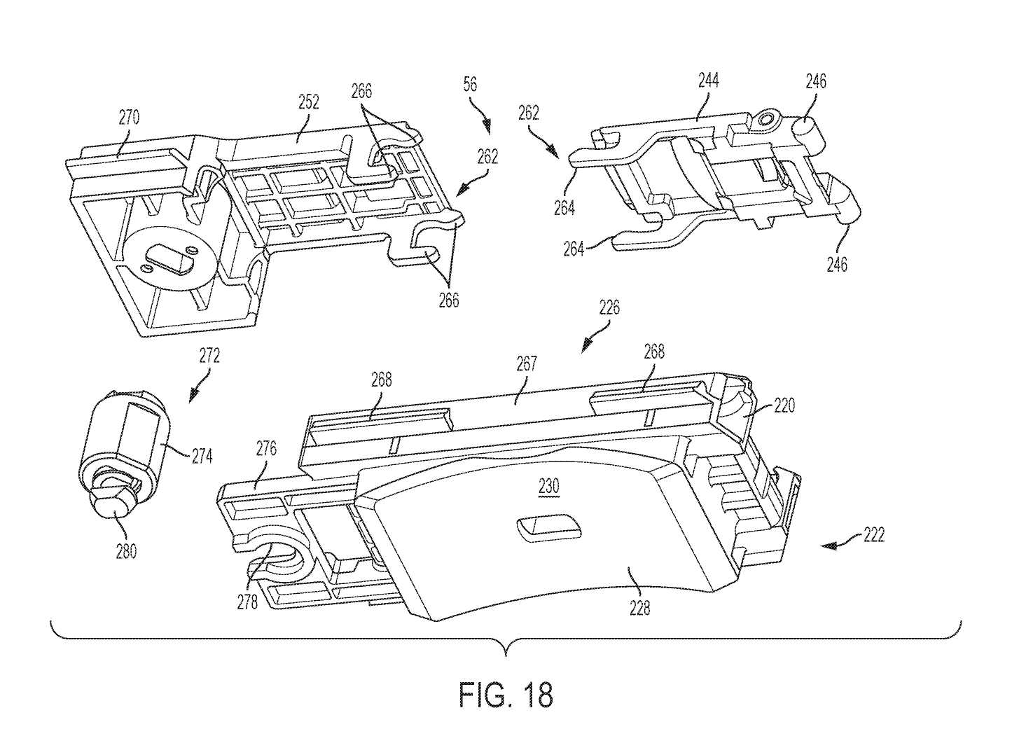

A locking mechanism 272 is included and configured to selectively lock the cover plate 252 in first position 254. Locking mechanism 272 may be present in any crossbar clamp, but a selected one of the clamps may be sufficient to secure the entire carrier. Locking mechanism 272 may be configured to selectively lock cover plate 252 to lower portion 228 of body 220 (or an extension thereof). For example, as shown in FIGS. 17-18, cover plate 252 may include a lock cylinder 274 and the lower portion of body 220 may include an extension plate 276 having an aperture 278 configured to mate with a cam 280 of lock cylinder 274.

### Additional Examples and Illustrative Combinations

This section describes additional aspects and features of cargo carrier systems according to the present teachings, and related systems and methods, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A. A rack for securing cargo on top of a vehicle, comprising:

a front portion removably coupled to a rear portion, each having:
a frame rail with parallel raised side portions;
a transverse member generally perpendicular to the raised side portions;
a plurality of spaced apart longitudinal members spanning between the frame rail and the transverse member; and
a crossbar clamp slidably mounted on two of the plurality of spaced apart longitudinal members, and configured to selectively clamp a crossbar of the vehicle, wherein the frame rail of the front portion and the frame rail of the rear portion are configured to connect as a single continuous outer frame rail with parallel raised side portions.

A1. The rack of A, wherein each of the front frame portion and the rear frame portion include a curved wall portion spanning between the frame rail and the transverse member.

A2. The rack of A, further including one or more transverse bars configured to selectively clamp to a first raised side portion and a second raised side portion of the outer frame rail.

A3. The rack of A2, wherein the one or more transverse bars each include two end clamps having a first jaw, a second jaw, and a bolt threadingly engaged with the second jaw to draw the second jaw toward the first jaw and secure a portion of the outer frame rail between the second jaw and the first jaw.

A4. The rack of A2, wherein the transvers bars are configured to be used as crossbars to secure rooftop rack accessories to the vehicle.

A5. The rack of A, further including a manually removable fairing configured to be coupled to a front end of the front frame portion.

A6. The rack of A5, wherein the fairing includes a plurality of collar clamps to selectively clamp the outer frame rail, each collar clamp including a toothed opening and a toothed member configured for ratcheting receipt in the toothed opening.

A8. The rack of A, wherein each crossbar clamp includes a strap with a first end coupled to a body of the clamp and a second end coupled to a cam lever, the cam lever being removable from the body of the clamp.

A9. The rack of A8, wherein the strap has an adjustable effective length.

A10. The rack of A, wherein a portion of one of the plurality of spaced apart longitudinal members includes an outer toothed surface configured to engage an inner toothed surface of one of the crossbar clamps.

A11. The rack of A, wherein a first hollow end of the frame rail of the front portion is connected to a second hollow end of the frame rail of the rear portion by an insert having a first connecting portion received in the first hollow end, a second connecting portion received in the second hollow end, and a central portion not received in either hollow end, the central portion having a cross section matching the cross sections of the first and second hollow ends.

B. A rack for securing cargo on top of a vehicle, comprising:

an outer frame rail with parallel and opposing raised side portions;

a plurality of longitudinal members generally parallel the raised side portions, each having a first end fixed to the outer frame rail and a second end fixed to a transverse rail; and

a plurality of crossbar clamps each mounted on a pair of adjacent longitudinal members of the plurality of longitudinal members, each having an open position and a closed position, and each being configured to fix the rack to a crossbar of the vehicle when in the closed position;

wherein the crossbar clamp is movable along the pair of adjacent longitudinal members when in the open position, and is fixed to the pair of adjacent longitudinal members when in the closed position.

B1. The rack of B, wherein the rack includes a front portion and a rear portion, removably coupled together.

B2. The rack of B1, wherein each of the front portion and the rear portion include two or more crossbar clamps of the plurality of crossbar clamps.

B3. The rack of B, wherein one of each pair of adjacent longitudinal members includes a toothed portion configured to engage a toothed portion of the mounted crossbar clamp.

B4. The rack of B, further including a removable fairing configured for attachment to the outer frame rail.

B5. The rack of B4, wherein the fairing is removable without the use of tools.

B6. The rack of B, further including a pair of transverse bar members configured for selective bridging attachment to different locations along the raised side portions of the outer frame rail.

C. A rack for securing cargo on top of a vehicle, comprising:

a frame including front portion and a rear portion, each having:
a plurality of parallel longitudinal members, spanning between an outer frame rail and a transverse frame rail; and
a pair of curved wall portions spanning between the outer frame rail and the transverse rail;

a pair of transverse bars configured for selective bridging attachment between a plurality of locations on the outer frame rail of the front portion and the outer frame of the rear portion; and

a removable fairing configured for attachment to the outer frame rail of the front portion.

C1. The rack of C, wherein the fairing is removable without the use of tools.

C2. The rack of C1, wherein the fairing includes a plurality of collar clamps to selectively clamp the outer frame rail for the front portion, each collar clamp including a toothed opening and a toothed member configured for ratcheting receipt in the toothed opening.

C3. The rack of C, wherein each of the pair of transverse bars includes two end clamps having a first jaw, a second jaw, and a bolt threadedly engaged with the second jaw to draw the second jaw toward the first jaw and secure a portion of the outer frame rail between the second jaw and the first jaw.

C4. The rack of C, wherein the transvers bars are configured to be used as crossbars to secure rooftop rack accessories to the vehicle.

D. A rack for securing cargo on top of a vehicle, comprising:

a front partial frame structure removably coupled to a rear partial frame structure, each frame structure including:
a perimetral rail portion having parallel raised side portions, and
a transverse crossbar member mounted on the raised side portions and generally orthogonal to the raised side portions.

D1. The rack of D, wherein the crossbar member is adjustable along the raised side portions.

D2. The rack of D, wherein one of the partial frame structures is interchangeable with a third partial frame structure of a different dimension configured to create vehicle cargo carriers of different sizes.

D3. The rack of D, wherein each partial frame structure has a plurality of spaced apart longitudinal members connected to the rail portion, the longitudinal members being parallel to each other and to the direction of vehicle travel.

D4. The rack of D3, further comprising:

a crossbar clamp device slidably mounted on one of the longitudinal members, and configured to selectively clamp a crossbar of the vehicle.

D5. The rack of D4, wherein the clamp device is mounted on two adjacent longitudinal members.

D6. The rack of D4, wherein said one of the longitudinal members has an array of transverse grooves on a bottom side configured to engage an array of ridges on a top side of the clamp device for fixing a desired longitudinal location of the clamp device along said one of the longitudinal members.

D7. The rack of D4, wherein the clamp device includes a strap having an adjustable effective length.

D8 The rack of D, wherein each of the frame structures has a pair of clamp devices, each clamp device being slidably mounted on a different longitudinal member.

E. A rack for securing cargo on top of a vehicle, comprising:

a frame structure including a perimetral rail portion having parallel raised side portions,

a clamp device configured to connect the frame structure to a crossbar on top of a vehicle, and

a first transverse crossbar member mounted on the raised side portions and generally orthogonal to the raised side portions, the crossbar member being adjustably moveable along the side portions and configured to support cargo securing devices.

E1. The rack of E, further comprising:

a second transverse crossbar member mounted on the raised side portions and generally orthogonal to the raised side portions, the crossbar member being adjustably moveable along the side portions and configured to support cargo securing devices in cooperation with the first transverse crossbar member.

E2. The rack of E, wherein the frame structure includes a front partial frame portion removably coupled to a rear partial frame portion.

F. A rack for securing cargo on top of a vehicle, comprising:

a frame structure configured to securely carry a load in transit, the frame structure having a first longitudinal member configured to extend perpendicular to a crossbar, and

a clamp device connected to the first longitudinal member, configured to couple the frame structure to a crossbar, wherein the clamp device is adjustable along a length of the first longitudinal member.

F1. The rack of F, wherein the first longitudinal member has an array of transverse grooves on a bottom side configured to engage an array of ridges on a top side of the clamp device for fixing a desired longitudinal location of the clamp device along the first longitudinal member.

F2. The rack of F, wherein the frame structure includes a front partial frame portion removably coupled to a rear partial frame portion, the first longitudinal member being connected to the front partial frame portion, a second longitudinal member being connected to the rear partial frame portion, each of the first and second longitudinal members having a clamp device adjustably connected to a bottom side.

F3. The rack of F, wherein the clamp device includes a strap having an adjustable effective length.

F4. The rack of F, wherein the frame structure has a second longitudinal member parallel and adjacent to the first longitudinal member, the clamp device being mounted on both of the first and second longitudinal members.

F5. The rack of F4, wherein the clamp device is slidable along the second longitudinal member.

G. A rack for securing cargo on top of a vehicle, comprising:

a front partial frame structure removably coupled to a rear partial frame structure, each of the partial frame structures having a tubular end portion, and

a coupler configured to securely engage the two tubular end portions without a tool.

G1. The rack of G, wherein the coupler has first and second end portions, each end portion being dimensioned to fit inside one of the tubular end portions, and having an angled slot configured to pull the tubular end portions toward each other by manually twisting the coupler.

H. A rack for securing cargo on top of a vehicle, comprising:

a basket assembly configured for attachment to a pair of crossbars on top of a vehicle, the basket assembly having a front frame portion including a tubular structure, and

a fairing expanse having a coupler configured to reversibly connect the fairing expanse to the tubular structure manually without a tool.

H1. The rack of H, wherein the coupler has first and second end portions, each of the end portions having a tab, one of the tabs being configured for connection directly to the fairing expanse, and each of the end portions having ratcheting structure for engaging the other end portion manually without a tool.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

The various structural members disclosed herein may be constructed from any suitable material, or combination of materials, such as metal, plastic, nylon, plastic, rubber, or any other materials with sufficient structural strength to withstand the loads incurred during use. Materials may be selected based on their durability, flexibility, weight, and/or aesthetic qualities.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variance.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A rack for securing cargo on top of a vehicle, comprising:
a front partial frame structure removably coupled to a rear partial frame structure, each frame structure including:
a perimetral rail portion having parallel raised side portions, and
a transverse crossbar member mounted on the raised side portions and generally orthogonal to the raised side portions.

2. The rack of claim 1, wherein the crossbar member is adjustable along the raised side portions.

3. The rack of claim 1, wherein one of the partial frame structures is interchangeable with a third partial frame structure of a different dimension configured to create vehicle cargo carriers of different sizes.

4. The rack of claim 1, wherein each partial frame structure has a plurality of spaced apart longitudinal members connected to the rail portion, the longitudinal members being parallel to each other and to the direction of vehicle travel.

5. The rack of claim 4, further comprising:
a crossbar clamp device slidably mounted on one of the longitudinal members, and configured to selectively clamp a crossbar of the vehicle.

6. The rack of claim 5, wherein the clamp device is mounted on two adjacent longitudinal members.

7. The rack of claim 5, wherein said one of the longitudinal members has an array of transverse grooves on a bottom side configured to engage an array of ridges on a top side of the clamp device for fixing a desired longitudinal location of the clamp device along said one of the longitudinal members.

8. The rack of claim 5, wherein the clamp device includes a strap having an adjustable effective length.

9. The rack of claim 1, wherein each of the frame structures has a pair of clamp devices, each clamp device being slidably mounted on a different longitudinal member.

10. A rack for securing cargo on top of a vehicle, comprising:
a frame structure configured to securely carry a load in transit, the frame structure having a first longitudinal member configured to extend perpendicular to a crossbar, and
a clamp device connected to the first longitudinal member, configured to couple the frame structure to a crossbar, wherein the clamp device is adjustable along a length of the first longitudinal member.

11. The rack of claim 10, wherein the first longitudinal member has an array of transverse grooves on a bottom side configured to engage an array of ridges on a top side of the clamp device for fixing a desired longitudinal location of the clamp device along the first longitudinal member.

12. The rack of claim 10, wherein the frame structure includes a front partial frame portion removably coupled to a rear partial frame portion, the first longitudinal member being connected to the front partial frame portion, a second longitudinal member being connected to the rear partial frame portion, each of the first and second longitudinal members having a clamp device adjustably connected to a bottom side.

13. The rack of claim 10, wherein the clamp device includes a strap having an adjustable effective length.

14. The rack of claim 10, wherein the frame structure has a second longitudinal member parallel and adjacent to the first longitudinal member, the clamp device being mounted on both of the first and second longitudinal members.

15. The rack of claim 14, wherein the clamp device is slidable along the second longitudinal member.

16. A rack for securing cargo on top of a vehicle, comprising:
a frame structure including a perimetral rail portion having parallel raised side portions,
a clamp device configured to connect the frame structure to a crossbar on top of a vehicle, and
a first transverse crossbar member mounted on the raised side portions and generally orthogonal to the raised side portions, the crossbar member being adjustably moveable along the side portions and configured to support cargo securing devices.

17. The rack of claim 16, further comprising:
a second transverse crossbar member mounted on the raised side portions and generally orthogonal to the raised side portions, the crossbar member being adjustably moveable along the side portions and configured to support cargo securing devices in cooperation with the first transverse crossbar member.

18. The rack of claim 16, wherein the frame structure includes a front partial frame portion removably coupled to a rear partial frame portion.

19. The rack of claim 16, wherein the frame structure has a front frame portion including a tubular structure, and further including a fairing expanse having a coupler configured to reversibly connect the fairing expanse to the tubular structure manually without a tool.

20. The rack of claim 19, wherein the coupler has first and second end portions, each of the end portions having a tab, one of the tabs being configured for connection directly to the fairing expanse, and each of the end portions having ratcheting structure for engaging the other end portion manually without a tool.
